(19) United States
(12) Patent Application Publication
(10) Pub. No.: US 2008/0216930 A1
(43) Pub. Date: Sep. 11, 2008

(54) Tyre with rubber tread which contains internal circumferential rubber stabilizer bars

(76) Inventors: Christopher John Valentine, Coventry (GB); David Robert Watkins, Sutton Coldfield (GB)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/713,847

(22) Filed: Mar. 5, 2007

(51) Int. Cl. B60C 11/00

(52) U.S. Cl. 152/209.5

(57) ABSTRACT

This invention relates to a tyre, particularly a motorcycle tyre having a high camber rubber tread which contains a central internal circumferential rubber stabilization element, or bar, which extends to and is a part of the running surface of the tyre tread and a plurality of additional spaced apart internal circumferential rubber stabilization bars, positioned within the tread outer cap rubber layer of which one or more may optionally be a part of the running surface of the tyre tread. In one embodiment, segments of the tread's outer cap rubber layer are substantially separated from each other, and may be thereby substantially dynamically de-coupled from each other, by one or more of said circumferential rubber stabilizer bars which extend radially outward into said outer tread cap rubber layer from an underlying tread base rubber layer.

### FIELD OF THE INVENTION

This invention relates to a tyre, particularly a motorcycle tyre having a high camber rubber tread which contains a central internal circumferential rubber stabilization element, or bar, which extends to and is a part of the running surface of the tyre tread and a plurality of additional spaced apart internal circumferential rubber stabilization bars, positioned within the tread outer cap rubber layer of which one or more may optionally be a part of the running surface of the tyre tread. In one embodiment, segments of the tread's outer cap rubber layer are substantially separated from each other, and may be thereby substantially dynamically de-coupled from each other, by one or more of said circumferential rubber stabilizer bars which extend radially outward into said outer tread cap rubber layer from an underlying tread base rubber layer.

### BACKGROUND OF THE INVENTION

High performance tyres such as motorcycle tyres having high camber (convex shaped) rubber treads which, in transverse cross-section, are sharply curved (highly cambered) to provide good contact with the road surface under a wide range of driving conditions, including when the motorcycle is steeply banked in cornering. Maintenance of stability of such motorcycle tread with a consistent ground contact area or “tyre footprint” under a wide range of driving conditions can be important for motorcycle handling, particularly, for example, over varied terrain such as, for example, on a motorcycle race circuit. Promoting high motorcycle cornering power with good tyre tread lateral stability at relatively high cornering speeds under race conditions is an important consideration for a highly cambered motorcycle tyre tread.

Historically, U.S. Pat. No. 6,988,520 proposes a motorcycle tyre of a highly cambered tread configuration which presents a dual rubber running surface composed of two different tread rubber compounds. The tyre tread is composed of a relatively soft first tread rubber layer underlying a second harder tread rubber layer which is centered over the softer first tread layer.

Further, EP-A-774 367 patent publication proposes the use of two different tread compounds for a motorcycle race tyre where one side of the tread is provided with high grip rubber compound and the other side with a harder rubber compound. The tyre construction is provided for motorcycle race circuits where the majority of bends of the race circuit are in the same direction.

Also, Japanese Patent Publication 61-211106 proposes a motorcycle tyre with a tread formed with three separate rubber compound zones each of which is of a full tread thickness.

In the description of this invention, the term “camber” or “camber value” relates to the ratio “H/W” as a ratio of the axial distance “H”, or “height” from the tread's outer running surface to an imaginary line extending axially between the outer edges of the tread divided by the radial distance “W”, or width”, from the center of the tread's outer running surface to an outer edge of the tread, particularly the outer edge of the extended running surface (e.g. when the motorcycle is turning at a considerable angle) of the tyre. A highly cambered (convex shaped) high performance motorcycle tyre tread may have a H/W ratio of, for example, in a range of from about 0.4 to about 0.8.

The terms “axial” and “axially” refer to a direction that is parallel, or substantially parallel, to the axis of the intended rotation of the tyre.

The terms “radial” and “radially” refer to a direction that is radially outward from, or radially inward to, in a sense of being at a right angle (about 90° C.) or substantially at a right angle to, the axis of the intended rotation of the tyre.

In the description of this invention, rubber compound, rubber composition, rubber blend and compounded rubber are terms which may be used interchangeably, unless otherwise indicated, to refer to rubber which has been mixed with rubber compounding ingredients. The terms “rubber” and “elastomer” are used interchangeably unless otherwise indicated. The term “phr” refers to parts by weight of an ingredient per 100 parts by weight of rubber in a rubber composition. Such terms are well known to those having skill in such art.

### SUMMARY AND PRACTICE OF THE INVENTION

In accordance with this invention, a tyre, particularly a motorcycle tyre having a highly cambered tread (convex shaped with the primary road-contacting portion of the tread being in the axial central portion of the circumferential tread) is provided wherein said tread is comprised of a cap/base construction having an outer tread cap rubber layer with a tread running surface and an underlying tread base rubber layer (underlying said tread cap rubber layer);

wherein said outer tread cap rubber layer contains a central circumferential rubber stabilizer bar and a plurality of at least two, preferably at least three, additional individual spaced apart, (spaced apart from each other and said central stabilizer bar), circumferential internal rubber stabilizer bars;

wherein said central and additional rubber stabilizer bars are a part of said tread base rubber layer which extend radially outward into said outer tread cap rubber layer and which are a unitary part of and of the same rubber composition as the said tread base rubber layer, and

wherein said central internal rubber stabilizer bar extends to and is a portion of the running surface of the tread.

In practice, the rubber composition of said central and additional internal rubber stabilizer bars and said tread base rubber layer is harder rubber composition (e.g. greater Shore A, 100° C., hardness) than the rubber composition of the outer tread cap rubber layer to promote dimensional stability for the outer tread cap rubber layer.

In practice, the rubber composition of said outer tread cap rubber layer is softer (e.g. lower Shore A, 100° C., hardness) than the rubber composition of said central and additional internal rubber stabilization bars and said tread base rubber layer to promote traction for the running surface of the tread.

In practice, the portion of said circumferential central stabilizer bar which becomes a portion of the running surface of the tyre tread abridges the axial centerline of the tread and occupies from about 20 to about 40 percent of the running surface of the tread.

In practice, the said circumferential central stabilizer bar divides the outer tread cap rubber layer into two axial circumferential tread segments, with one of said segments positioned on each side of said circumferential central stabilizer bar.

In one embodiment, said two circumferential tread segments are physically separated from each other by said (harder) circumferential central stabilizer bar to thereby promote dimensional stability of the tyre tread, particularly for said outer tread cap rubber layer.

In a further embodiment, said two circumferential tread segments are dynamically de-coupled from each other by said (harder) circumferential central stabilizer bar, (in a sense of not ordinarily completely transmitting forces generated by one of said segments to the other segment), to thereby promote dimensional stability of the tyre tread, particularly for said outer tread cap rubber layer.

In one embodiment, at least a portion of said additional circumferential internal rubber stabilization bars (in addition to said central stabilization bar) extend substantially through and thereby substantially divide the said outer tread cap rubber layer into individual sub-segments.

Accordingly, in an additional embodiment, at least a portion of said individual outer tread cap sub-segments are substantially physically separated from each other by said stabilizer bars to thereby further promote dimensional stability for the tyre tread, particularly for the tread outer tread cap layer.

Accordingly, in an additional embodiment, at least a portion of said individual outer tread cap sub-segments are substantially dynamically de-coupled from each other by said stabilizer bars in a sense of not ordinarily completely transmitting forces generated by one of said segments to the other segment to thereby promote dimensional stability of the tyre tread, particularly for said outer tread cap rubber layer.

In a desirable practice, the rubber composition of the tread base rubber layer and central and additional stabilizer bars is at least 5 Shore A (100° C.) hardness units greater than the rubber composition of the tread outer cap rubber layer.

In one embodiment, the rubber composition of the tread base rubber layer and associated central and additional stabilizer bar extensions thereof has a Shore A (100° C.) hardness value in a range of from about 46 to about 60 and at least 5 of such Shore A hardness units greater than the Shore A (100° C.) hardness of said tread cap layer rubber composition.

In a further embodiment, the rubber composition of the tread base rubber layer and associated central and additional stabilizer bar extensions thereof has a 300 percent dumb bell tensile modulus at 100° C. in a range of from about 5.1 to about 9.0 MPa and at least 1 MPa greater than said tensile modulus of said tread cap layer rubber composition.

In one embodiment, the rubber composition of the tread outer cap rubber layer has a Shore A hardness value at 100° C. in a range of from about 35 to about 45.

In a further embodiment, the rubber composition of the tread outer cap rubber layer has a 300 percent dumb bell tensile modulus at 100° C. in a range of from about 2.5 to about 4.9 MPa.

In practice, said tread may contain, for example, a total of from 2 through 18, alternately from 6 to, and including, 10, of said additional stabilizer bars.

Said additional stabilizer bars may be positioned in equal numbers on each side (in an axial direction) of said central internal stabilizer bar.

In practice, the central stabilizer bar may abridge the axial midline (EP) of the tread in a manner to provide said two tread cap rubber layer sections of about (approximately) equal axial running surface widths.

In practice, for an optional asymmetrical tyre tread, the central stabilizer bar may abridge the axial midline (EP) of the tread in a manner to provide said two tread cap rubber layer sections of unequal running surfaces. For example, the running surface of one lateral tread cap outer rubber layer section may occupy at least a 20 greater percent of the tread running surface than the other tread cap outer rubber layer section. For a further example, one lateral tread outer rubber layer section may comprise from about 20 to about 30 percent of the tread running surface and the other lateral tread cap outer rubber layer may comprise from about 40 to about 50 percent of the tread running surface, (wherein said central stabilizer occupies the aforesaid from about 20 to about 40 percent of the tread running surface).

In practice, for an asymmetrical tyre tread, the said additional rubber stabilizer bars may be distributed unequally within said two lateral sections of said outer tread cap rubber layer to thereby divide said two lateral sections of said outer tread cap rubber layer into an unequal number of sub-sections therein.

For example, where the running surface of said tyre tread contains from 2 to 18 subsections (created by said stabilizer bar extensions from said tread base rubber layer), one lateral outer tread layer section may contain from 1 to 9 subsections, with the other and remaining lateral tread layer section containing the remaining subsections, so long as one of said tread sections contain at least one more subsection than the other tread section.

In one embodiment, while said additional stabilizer bars may be of various shapes, preferably they are of a general triangular shape configuration with their base being a part of (and of the same rubber composition) the tread base rubber layer, and their apex, which may be an entruncated apex) extends to the running surface of the tread. In such case, while an individual additional stabilizing element may constitute less than about 1 percent of the running surface of the tread, as the tread wears, it may eventually constitute, for example, up to 5 percent or more of the running surface of the tyre tread, to thereby further enhance the dimensional stability (e.g. the axial stability) of the outer tread cap rubber layer as the tread wears away during use.

In one embodiment, such triangles, whether or not having entuncated apex's, may be substantially equilateral in shape and therefore have inclusive angles of about 60°.

In practice, said tread preferably has a camber with a W/L ratio in a range of from about 0.4 to about 0.8.

In practice, the overall average tread thickness may vary, for example, from about 4 to about 8 mm at the midline (EP), (the axial midline) of the tyre to about 5 to about 12 mm at the lateral outer edges of the tread, depending somewhat upon the size of the individual tyre and its intended use.

In practice, the tread base rubber layer typically extends across the width, or at least a major portion of the width, of the tread and, other than said extensions thereof to form said central stabilizer bar and said additional stabilizer bars, may have a thickness, for example, ranging from about 8 to about 90, alternately from 8 to about 20, percent of the overall tread thickness, namely the combination of said outer tread cap rubber layer and said tread base rubber layer, depending somewhat upon the portion of the tread to be taken into consideration and upon the tyre size and its intended use.

### DESCRIPTION OF THE DRAWINGS

Further aspects of the present invention will become apparent from the description of the following embodiments in conjunction with the attached diagramatic drawing in which:

FIG. 1 is presented to illustrate a cross-section of a motorcycle tyre (1) having a wide convex tread (2) intended for use in high performance racing wherein the convex tread (2) is highly cambered and contains internal rubber stabilizer bars.

The illustrated convex shaped tyre tread (2) is intended to be representative of (not necessarily exact in the drawing) a camber value (H/W) of about 0.6.

The tyre tread is of a cap/base construction comprised of an outer Tread Cap Layer (3) and an underlying Tread Base Layer (4).

For this drawing presentation, the tread base rubber layer (4) is comprised of a harder rubber composition than the rubber composition of the outer tread cap rubber layer (3).

A central stabilizer bar (4A) is a part of and an extension of said tread base rubber layer (4) through said tread cap layer (3) to and including a portion of the tread running surface (7) and which abridges the axial midline (EP) of the tread.

The central stabilizer bar (4A) divides the outer tread cap rubber layer into two substantially equal lateral sections (5A) and (5B). The two sections (5A) and (5B) are physically separated and dynamically de-coupled from each other by said central stabilizer bar (4A) to promote a dimensional stability for the tyre tread particularly for a motorcycle during turning maneuvers.

The central portion of the tread running surface (7), composed of the central stabilizer bar (4A) as an extension of the harder tread base rubber layer (4) extends, for the purposes of this drawing, over about 25 percent of the tread running surface (7).

Six additional, spaced apart, stabilizer bars (4B) are shown as being evenly distributed on each side, namely three on each side, of the central stabilizer bar (4A). The stabilizer bars (4B) are of a generally triangular configuration and extend from the tread base rubber layer (4) radially outward into and through the tread cap layer (3) with their apex's extending to a running surface (7) of the tyre. The outer tread cap layer (3) is divided into individual subsections (3A) in one lateral section (5A) of the tread cap layer (3) and individual subsections (3B) of the other lateral section (5B) of the tread cap layer (3).

The softer rubber of the tread cap outer layer (3) is provided to promote good grip (traction), particularly on motorcycle cornering, when the tyre is mostly at a significant angle to a vertical position in a manner that most of the contact of the tyre with the ground involves one of the two separate, de-coupled axial lateral sections of the tread softer rubber composition (3) to thereby promote enhanced traction and control of the tyre.

The harder rubber of the tread base rubber layer (4), which includes the central stabilizer bar (4A) and the plurality of additional stabilizing bars (4B) as extensions of the tread base rubber layer (4), is provided to promote low temperature generation (cooler running) in straight line vehicular (motorcycle) running, as well as dimensional stability, when the tyre (1) is mostly in a vertical, upright position to promote the control of the tyre in such running condition.

For this descriptive drawing, the properties of the tread cap rubber layer (3) include a Shore A hardness value at 100° C. of about 35 to about 49 and a 300 percent dumb-bell tensile modulus at 100° C. and 300 percent extension of less than 5 MPa, namely from about 2.5 to about 4.9 MPa.

In contrast, for this descriptive drawing, the properties of the tread base harder rubber layer (4) include a Shore A hardness value at 100° C. in a range of from about 46 to about 60, and at least about 5 units greater than the Shore A hardness of said tread cap softer rubber layer (3) and a 300 percent dumb-bell tensile modulus at 100° C. and 300 percent extension of about 5.1 to about 9 MPa and at least 1 MPa greater than that of the said tread cap rubber layer (3).

The following Example is provided to better understand the invention. The parts and percentages are by weight unless otherwise indicated.

### EXAMPLE

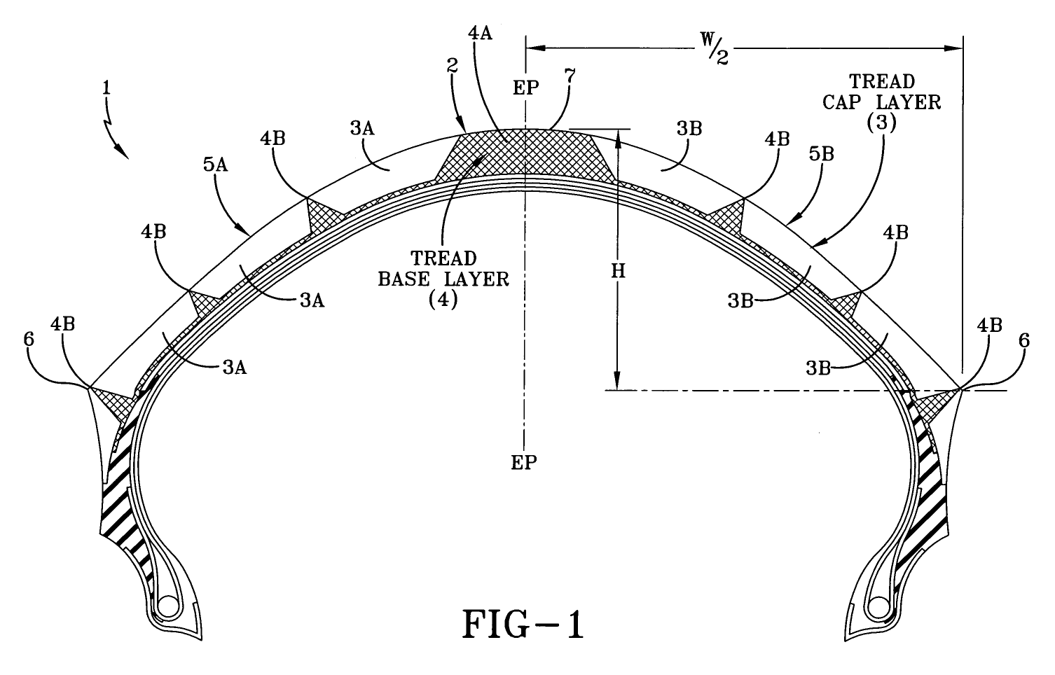

Rubber compositions were prepared for a motorcycle tyre tread identified herein as Sample A and Sample B for a motorcycle tyre tread configuration similar to FIG. 1.

Sample A is intended to be a softer, tread traction promoting, rubber composition for an outer tread cap rubber layer for a motorcycle tyre tread.

Sample B is intended to be a harder (stiffer) rubber composition for an underlying tread base rubber layer for a motorcycle tyre tread and for the aforesaid central internal stabilizer bar and additional internal stabilizer bars.

The rubber compositions are illustrated in the following Table 1 where parts are by weight unless otherwise indicated.

TABLE 1

| | Samples (parts | |
|---|---|---|
| | by weight) | |
| | Softer | Harder |
| Material | A | B |
| Non-Productive Mixing | | |
| S-SBR rubber¹ | 80 | 100 |
| S-SBR rubber² | 20 | 0 |
| Carbon black³ | 90 | 86 |
| Stearic acid⁴ | 1.3 | 1.4 |
| Zinc oxide | 4 | 4.1 |
| Rubber processing oil & polymer extender oil | 78 | 65 |
| Antioxidants and processing aids | 16.5 | 13.4 |
| Productive Mixing Step | | |
| Sulfur | 1.7 | 2 |
| Accelerator(s)⁵ | 2.6 | 3.6 |

¹Organic solvent solution polymerization prepared styrene/butadiene (SBR) rubber
²Organic solvent solution polymerization prepared styrene/butadiene (SBR) rubber
³High structure SFA type rubber reinforcing carbon black
⁴Comprised of primarily of stearic acid (e.g. at least 90 weight percent stearic acid)
⁵Vulcanization accelerators of the sulfenamide and diphenyl guanidine types

Various physical properties of the Samples of Table 1 are reported in Table 2.

TABLE 2

| | Samples | |
|---|---|---|
| | Softer | Harder |
| Properties | A | B |
| Shore A Hardness | | |
| (cured at 165° C. for about 21 minutes) | | |
| 100° C. (ASTMD-2240) | 39 | 48 |
| Stress-strain | | |
| Tensile strength (dumb-bell) (MPa) | 9.8 | 9.3 |
| Elongation (dumb-bell) (%) | 601 | 453 |
| Modulus (300%), 100° C., dumb-bell (MPa) | 3.6 | 5.7 |

A highly cambered motorcycle tyre of size 200/70R420 was prepared having a tread of a cap/base construction and a first circumferential rubber stabilizer bar and six additional, spaced apart, circumferential rubber stabilizer bars similar to the motorcycle tyre of FIG. 1 of rubber compositions comprised of softer Sample A of Example I for the tread cap rubber layer and harder Sample B of Example I for the tread base rubber layer and central and additional internal rubber stabilizer bars.

The resultant motorcycle tyre was observed to provide good precision and lateral stability in cornering conditions in which the lateral sections and sub-sections of the tread cap softer rubber layer (rubber Sample A) were involved in ground-contacting and in straight running conditions in which the central harder rubber stabilizer portion (rubber Sample B) was primarily involved with ground-contacting.

While certain representative embodiments and details have been shown for the purpose of illustrating the subject invention, it will be apparent to those skilled in this art that various changes and modifications can be made therein without departing from the scope of the subject invention.

What is claimed is:

1. A tyre having a highly cambered tread wherein said tread is comprised of a cap/base construction having an outer tread cap rubber layer with a tread running surface and an underlying tread base rubber layer;
wherein said outer tread cap rubber layer contains a central circumferential rubber stabilizer bar and a plurality of at least two additional individual spaced apart, circumferential internal rubber stabilizer bars;
wherein said central and additional rubber stabilizer bars are a part of said tread base rubber layer which extend radially outward into said outer tread cap rubber layer and which are a unitary part of and of the same rubber composition as the said tread base rubber layer,
wherein said central internal rubber stabilizer bar extends to and is a portion of the running surface of the tread, and
wherein the rubber composition of said central and additional internal rubber stabilizer bars and said tread base rubber layer is has a Shore A (100° C.) hardness greater than the Shore A (100° C.) hardness of said outer tread cap rubber composition.

2. The tyre of claim 1 wherein the portion of said circumferential central rubber stabilizer bar which becomes a portion of the running surface of the tyre tread abridges the axial centerline of the tread and occupies from about 20 to about 40 percent of the running surface of the tread and wherein said tyre has a W/L camber in a range of from about 0.4 to about 0.8.

3. The tyre of claim 1 wherein the said circumferential central rubber stabilizer bar divides the outer tread cap rubber layer into two circumferential tread segments, with one of said segments positioned on each side of said circumferential central rubber stabilizer bar.

4. The tyre of claim 3 wherein the said two circumferential tread segments are separated from each other and are dynamically de-coupled from each other by said circumferential central rubber stabilizer bar.

5. The tyre of claim 1 wherein at least a portion of said additional circumferential internal rubber stabilization bars extend substantially through and thereby substantially divide the said outer tread cap rubber layer into individual sub-segments.

6. The tyre of claim 1 wherein at least a portion of said individual outer tread cap sub-segments are substantially physically separated from each other by said stabilizer bars.

7. The tyre of claim 1 wherein at least a portion of said individual outer tread cap sub-segments are substantially dynamically de-coupled from each other by said stabilizer bars.

8. The tyre of claim 1 wherein the rubber composition of the tread base rubber layer and central and additional stabilizer bars is at least 5 Shore A (100° C.) hardness units greater than the rubber composition of the tread outer cap rubber layer.

9. The tyre of claim 1 wherein the rubber composition of the tread base rubber layer and associated central and additional stabilizer bar extensions thereof has a Shore A (100° C.) hardness value in a range of from about 46 to about 60 and at least 5 of such Shore A hardness units greater than the Shore A (100° C.) hardness of said tread cap layer rubber composition.

10. The tyre of claim 1 wherein the rubber composition of the tread base rubber layer and associated central and additional stabilizer bar extensions thereof has a 300 percent dumb bell tensile modulus at 100° C. in a range of from about 5.1 to about 9.0 MPa and at least 1 MPa greater than said tensile modulus of said tread cap layer rubber composition.

11. The tyre of claim 1 wherein the rubber composition of the tread outer cap rubber layer has a Shore A hardness value at 100° C. in a range of from about 35 to about 45.

12. The tyre of claim 1 wherein the rubber composition of the tread outer cap rubber layer has a 300 percent dumb bell tensile modulus at 100° C. in a range of from about 2.5 to about 4.9 MPa.

13. The tyre of claim 1 wherein said tread contains a total of from 2 through 18 of said additional stabilizer bars.

14. The tyre of claim 1 wherein said tread contains at least 6 and a maximum of 10 of said additional stabilizer bars.

15. The tyre of claim 1 wherein said additional stabilizer bars are positioned in equal numbers on each side of said central internal stabilizer bar.

16. The tyre of claim 1 wherein the central stabilizer bar abridges the axial midline (EP) of the tread in a manner to provide said two tread cap rubber layer sections of approximately equal running surface widths.

17. The tyre of claim 1 wherein an asymmetrical tyre tread is provided wherein the central stabilizer bar abridges the axial midline (EP) of the tread in a manner to provide two tread cap rubber layer sections of unequal running surface widths.

18. The tyre of claim 16 wherein the running surface of one lateral tread cap outer rubber layer section occupies at least a 20 greater percent of the tread running surface width than the other tread cap outer rubber layer section.

19. The tyre of claim 1, wherein an asymmetrical tyre tread is provided wherein said additional rubber stabilizer bars are distributed unequally within said two lateral sections of said outer tread cap rubber layer to thereby divide said two lateral sections of said outer tread cap rubber layer into an unequal number of sub-sections therein;
wherein the running surface of said tyre tread contains from 2 to 18 subsections created by said stabilizer bar extensions from said tread base rubber layer and wherein one lateral outer tread layer section contains from 1 to 9 subsections with the other and remaining lateral tread layer section containing the remaining subsections, so long as one of said tread sections contains at least one more subsection than the other tread section.

20. The tyre of claim 1 wherein said additional stabilizer bars are of a general triangular shape configuration with at least one of an apex and entruncated apex extending to the running surface of the tread.
